(19) United States
(12) Patent Application Publication
(10) Pub. No.: US 2009/0295145 A1
(43) Pub. Date: Dec. 3, 2009

(54) DRAINING OR VENTING DEVICE FOR A COMPENSATOR

(75) Inventors: Joachim Conrad, Neukirchen (DE); Kay Degner, Munchen (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: Linde Aktiengesellschaft, Munchen (DE)

(21) Appl. No.: 12/476,575

(22) Filed: Jun. 2, 2009

(30) Foreign Application Priority Data
Jun. 3, 2008 (DE) 102008026596.9

(51) Int. Cl. F16L 55/00

(52) U.S. Cl. 285/13

(57) ABSTRACT

The invention relates to a draining or venting device for a compensator (15) that has a central interior space (17) and a peripheral formation (16), especially a corrugation (16), which surrounds an interior space (25) of the formation. The draining or venting device comprises a suction means (50) for sucking a fluid out of the interior space (25) of the formation, and a connecting line (30, 47) that establishes a flow connection between the interior space (25) of the formation and the suction means (50), the connecting line (30, 47) running through the central interior space (17) of the compensator (15) and running through a through opening (40) in one wall of a component (19) that is connected to the compensator (15).

The invention relates to a draining or venting device for a compensator. Moreover, the invention relates to a heat exchanger with a compensator and a draining or venting device for the compensator.

Compensators are required when, as a result of temperature or pressure stress, system components that are connected to one another expand or move relative to one another to different degrees. According to the prior art, these differences in the expansion of components can be accommodated by compensators. Compensators are used as equalizers of expansion or motion on equipment such as heat exchangers, pipelines, pumps, motors, turbines and machinery.

A compensator is generally formed as a tubular element with a corrugated or folded structure that has at least one formation that runs around the periphery, for example in the form of a corrugation or a fold. The corrugation can be made, for example, in the form of a ring that is open to the inside and that runs around the periphery of the compensator. A compensator can have a single corrugation or several corrugations or folds. Similarly to an accordion and as a result of its corrugated or folded structure, the compensator can be pulled apart or pressed together. Compensators can be formed from elastomer materials such as rubber, or from metal. In the case of a metal design, compensators with one or more peripheral formations or corrugations can also be referred to as metal bellows compensators.

Especially for a horizontal arrangement of such a compensator, the corrugations or formations enclose spaces in which liquid or gas collects that cannot be drained by gravity. Among others, this constitutes a safety risk when the system is to be maintained and dangerous gases or liquids remain in the formation or the corrugation of the compensator. Moreover, it is desirable to completely remove all fluids from a system from time to time, since in the operation of a system, substances can collect that can have an adverse effect on the processes taking place in the system.

In order to solve this problem, it would be possible in the respective corrugation or fold of the compensator to form a closable drain or vent opening. In compensators with a wall thickness of less than 2 mm, this is, however, technically difficult to do. Moreover, in general, manufacturers of compensators do not guarantee compensators that are provided with holes.

One object of this invention is therefore to provide a device with which complete or substantially complete residual draining or residual venting of a compensator is possible without violating the compensator wall in the region of the corrugation or the fold.

Upon further study of the specification and appended claims, other objects and advantages of the invention will become apparent, for example, a method of producing the device, a heat exchange incorporating the device as well as a method of using the heat exchanger.

These objects are achieved with a draining or venting device for a compensator that has a central, especially cylindrical, interior space and at least one peripheral formation, especially a corrugation which surrounds the interior space of a formation, the draining or venting device having a suction means for sucking a fluid out of the interior space of the formation, and a connecting line that establishes a flow connection between the interior space of the formation and the suction means, the connecting line running through the central interior space of the compensator and running through a through opening, especially a through hole, in one wall of a component that is connected to the compensator.

Accordingly, a draining or venting device for a compensator is provided that has a central, preferably cylindrical, interior space and at least one peripheral formation, for example a corrugation, that surrounds the interior of the formation, whereby the draining or venting device has: a suction means for sucking a fluid out of the interior space of the formation, and a connecting line that establishes a flow connection between the interior space of the formation and the suction means, the connecting line running through the central interior space of the compensator and running through a through opening, for example a through hole, in one wall of a component that is connected to the compensator. The advantage of this device is that the connecting line is routed through the central interior space of the compensator and runs to the outside via a through opening in an adjacent component. It is therefore unnecessary to make an opening in the compensator itself. Damaging the compensator by making a drain or vent hole is thus avoided. Thus, notch stresses in the compensator wall are avoided that would adversely affect the expansion behavior of the compensator. Since the compensator wall is intact, the guarantee of the manufacturer for the compensator remains in effect. By already applying a low vacuum that overcomes the gradient and the pressure loss of the connecting line, the fluid can be removed from the interior space of the formation by way of the connecting line.

The fluid that can be removed from the compensator can be a gas or a liquid. If the compensator has several formations such as corrugations, with several interior spaces of the formations, for each formation a flow connection to a suction means can be created. Preferably, the suction means comprises an electrically-driven pump. In general, however, it is also conceivable for a liquid in the interior space of the formation to be removed by a gradient using the siphon principle.

In the device according to the invention, the connecting line preferably projects into the interior space of the formation of the compensator. This has the advantage that a fluid located in the interior space of the formation can also be removed with a low vacuum. If a passage between the central interior space of the compensator and the interior space of the formation is too narrow to route a corresponding pipeline through, it is also possible to have the connecting line leading from the central interior space of the compensator in front of this passage. The connecting line then does not project into the interior space of the formation, but rather ends in front of the passage. By applying a corresponding vacuum or negative pressure, however, gaseous fluids can also be removed.

If a liquid is to be removed from the interior space of the formation, the device according to the invention preferably has a heating means for vaporizing the liquid located in the formation. The vaporized liquid can then also be removed using a line that ends in front of the passage. The heating means is preferably an electrical heating means such as, for example, a heating mat that is located on the outside of the formation.

The device according to the invention is preferably made such that (a) a first, inner part of the connecting line is formed by a pipeline that runs through the central interior space of the compensator and extends as far as or into the through opening, and (b) a second, outer part of the connecting line that leads to the suction means and can be flow-connected, via a pipe socket that is connected from the outside to the through opening, to the first, inner part of the connecting line. In the operation of the compensator, the pipe socket is preferably sealed by a blind flange. If the compensator is to be drained when out of operation, the second, outer part of the connecting line that leads to the suction means is connected to the pipe socket. In general, however, a configuration is also conceivable in which the inner part and the outer part of the connecting line are continuously connected and—by way of a valve in the connecting line—a flow connection between the interior space of the formation and the suction means is established or blocked. This can be a manually operated valve.

Preferably, the through opening is located in one wall of a tubular connecting part that is connected to the compensator and to the aforementioned first, inner part of the connecting line that runs through the central interior space of the compensator and extends as far as or into the through opening as a prefabricated unit. This simplifies installation of the draining or venting device at the system site. The connecting part then need be connected only to the corresponding system component, for example a jacket part, and the inner part of the connecting line must be connected to the outer part of the connecting line and thus must be flow-connected to the suction means.

In the device according to the invention, a first part of the connecting line that runs into the central interior space of the compensator, preferably the aforementioned first, inner part of the connecting line, has a diameter of less than 20 mm, preferably of less than 10 mm. This makes it possible to use the device according to the invention also for equipment or machinery in the interior of which there is less room for the connecting line. One example of this is the jacket space of heat exchangers with a straight tube bundle where there is too little room between the outer pipe circle and the inside of the jacket.

The draining or venting device according to the invention can be used for all types of compensators that have one or more formations in which fluids collect, which cannot be drained solely by gravity, during operation of the compensator. This is especially the case for a horizontal arrangement of a compensator in which at least one part of the formation or the interior space of the formation is underneath the lowest or above the highest wall section of a component that is connected to the compensator. The device according to the invention is preferably suited for compensators with corrugations in which the respective corrugation in the form of a ring runs around the essentially tubular body of the compensator, or else for compensators with corrugations that likewise run around an essentially tubular body of the compensator and have an essentially circular or elliptical cross-section. Since these corrugations can have large interior spaces of the corrugations, considerable amounts of fluids can collect here that cannot be drained by gravity. Preferably, the device according to the invention is intended for compensators that have a corrugation made of metal, preferably high-grade steel, with a wall thickness in the range from roughly 0.5 to 1.5 mm. In them, the arrangement of a venting or draining means on the wall of the corrugation is not possible.

The device according to the invention offers major advantages for heat exchangers, for example straight tube heat exchangers, in which the compensator connects the jacket parts of the heat exchanger to one another. As mentioned above, in these heat exchangers, there is little room in the jacket space, since the pipes border the jacket there, and there is little room between the pipes of the individual pipe circles. The part of the connecting line that runs into the central interior space of the compensator or into the jacket space of the heat exchanger can, however, be made very thin so that it has enough room between the outer pipe circle and the inside of the jacket. With the device according to the invention, even horizontally installed heat exchangers, which due to large temperature differences between the medium flowing in the jacket space and the medium flowing in the pipe space require a compensator that is located between the jacket parts, can thus be completely drained.

Preferably, the device according to the invention is used for a straight tube heat exchanger that is used in a synthesis gas or hydrogen facility, for example, as a preheater in which a feedstock, for example water or natural gas, is preheated in indirect heat exchange with hot synthesis gas. Due to the high temperature differences between the feedstock that flows through the jacket space and the hot synthesis gas that flows through the pipes, a compensator on the jacket is necessary. The latter can be completely drained, for example of natural gas, using the device according to the invention so that maintenance efforts such as welding can be done without danger to the maintenance personnel.

The device according to the invention can also be used for floating head heat exchangers with a straight tube bundle, a floating head with an attached pipe socket with a compensator, as is described in the patent application “Heat Exchanger with Straight Tube Bundle and Floating Head” (applicant file number 102007017227.5).

### BRIEF DESCRIPTION OF DRAWINGS

The invention as well as further details of the invention are explained in more detail below based on the embodiments shown in the drawings. Here:

FIG. 1 shows a straight tube heat exchanger with a compensator located between the jacket parts in a sectional view and a venting device for the compensator;

FIG. 2 shows an enlarged partial view of the compensator and the venting device from FIG. 1;

FIG. 3 shows another embodiment of a venting device for a compensator in the same view as FIG. 2;

FIG. 4 shows a draining device for a compensator.

To facilitate an understanding of the Figures, the following table presents a list explaining by order of number of the components.

Reference Number List

| | |
|---|---|
| Straight Tube Heat Exchanger | 1 |
| Jacket | 2 |
| Tube | 3 |
| Tube Bottom | 4, 5 |
| Prechamber | 6, 7 |
| Pipe Socket | 8, 9 |
| Jacket Space | 10 |
| Pipe Socket | 11, 12 |
| Jacket Part | 13, 14 |
| Compensator | 15, 15′ |
| Corrugation | 16, 16′ |
| Central Interior Space of the Compensator | 17, 17′ |
| Movable Bearing | 18 |
| Connecting Parts | 19, 20 |
| Fixed Bearing | 21 |
| Angled Sections of the Compensator | 22 |
| Gap | 23, 23′ |
| Interior Space of the Corrugation | 25, 25′ |
| Tubular Sections of the Compensator | 27 |
| Free End of the Tubular Section | 28 |
| Pipeline | 30, 30′, 130 |
| First Straight Section | 31 |
| First Bent Section | 32 |
| Second Straight Section | 33 |
| Second Bent Section | 34 |
| Third Straight Section | 35 |
| End of the Pipeline in the Interior Space of the | 36, 36′, 136 |
| Corrugation | |
| Through Opening, Through Hole | 40, 140 |
| Weld | 41, 42 |
| Pipe Socket | 44; 144 |
| Flange | 46 |
| Pipeline | 47; 147 |
| Pipeline | 48; 148 |
| Blind Flange | 49 |
| Pump | 50; 150 |
| Heating Means | 160 |

### DETAILED DESCRIPTION OF FIGURES

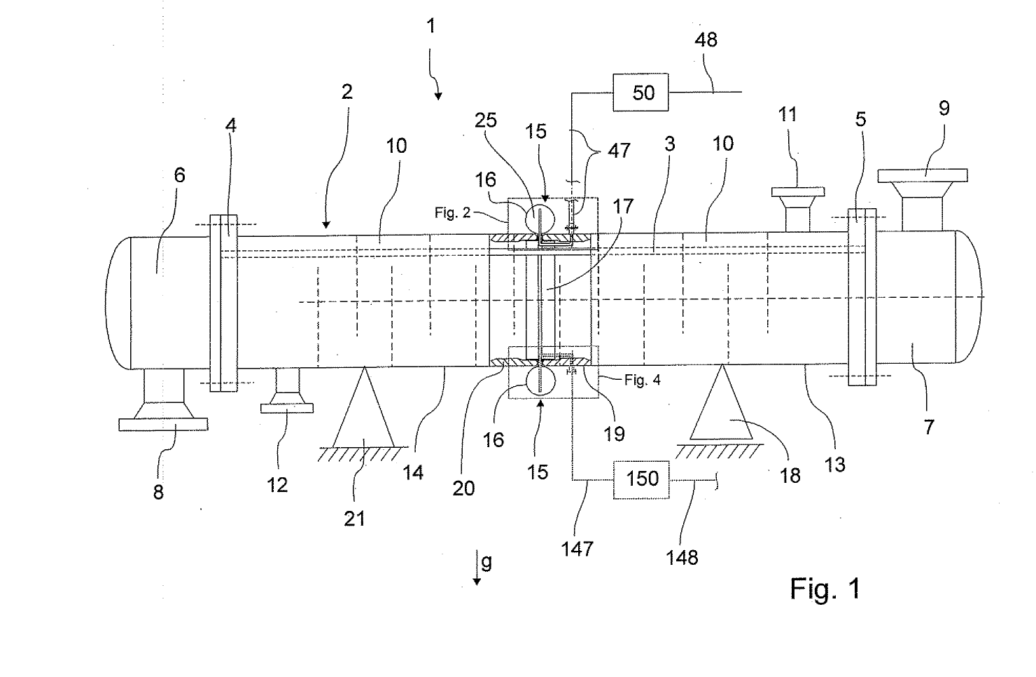

FIG. 1 shows a side view and a partial sectional view of a straight tube heat exchanger 1. The heat exchanger 1 comprises a jacket 2 and a tube bundle of straight tubes 3 that are located parallel to one another, of which only a single one is shown in the figure. On their ends, the tubes 3 are each supported in tube bottoms 4 and 5. Prechambers 6 and 7 with pipe sockets 8, 9 are connected by way of flange connections to the tube bottoms 4 and 5, and via said pipe sockets 8, 9, a first medium can be fed into the tubes 3 or discharged from the tubes 3. The tube bottoms 4 and 5 and the jacket 2 border an outside space around the tubes 3 that is called a jacket space 10 below. In the region of the jacket space 10 on the jacket 2 of the heat exchanger 1, there are pipe sockets 11 and 12 for feeding a second medium into the jacket space 10 or for removing the second medium from the jacket space 10.

In the region of the tubes 3, the jacket 2 of the heat exchanger 1 is formed from tubular jacket parts 13 and 14 that are connected to one another by way of a compensator 15. The compensator 15 is made in one layer and has a formation or corrugation 16 that runs around the periphery of the compensator 15. The compensator 15 is made of high-grade steel (chromium-nickel steel). As can be seen from FIG. 1, the compensator 15 is not attached directly to the jacket parts 13 and 14, but rather in each case by way of short, tubular connecting parts 19 and 20 that are made reinforced. The connecting parts 19 and 20 themselves form short sections of the jacket 2. Like the compensator 15, they are formed from high-grade steel (chromium-nickel steel) so that they can be easily connected to the compensator 15 by welding. The connecting parts 19 and 20 for their part are connected by welds to the two jacket parts 13 and 14.

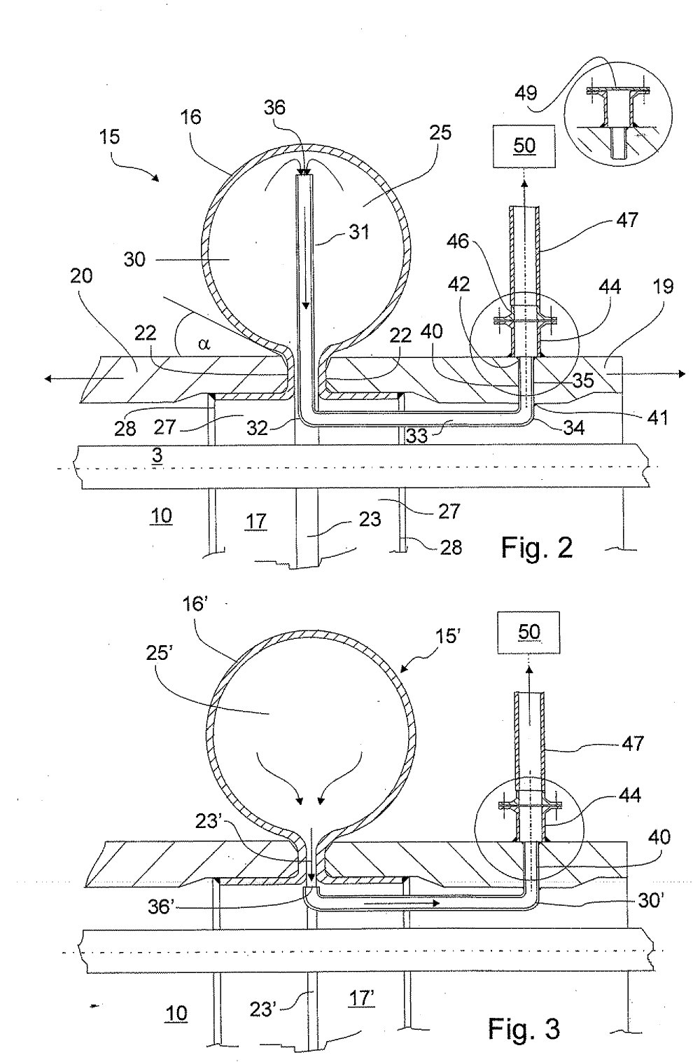

FIG. 2 shows an enlarged sectional view of the compensator 15 with adjacent components. The extract shown in FIG. 2 is shown in broken lines in FIG. 1. The compensator 15 is made in one layer with a wall thickness of less than 2 mm. It has a corrugation 16 that runs around the periphery and that is made essentially circular in cross-section. In several sections with the outside walls of the connecting parts 19 and 20, the corrugation 16 encloses an outside angle α of less than 900. The corrugation 16 can, however, be made differently from this example in cross-section essentially also as a circular segment or as an ellipse or partial ellipse. The corrugation 16 that is circular in cross-section is adjoined by angled sections 22. The angled sections 22 extend around the ends of the connecting parts 19 and 20 facing the compensator 15. Between the angled sections 22 of the compensator 15, there remains a gap 23 that runs around the periphery and that forms a passage from the central interior space 17 of the compensator 15 to an interior space 25 of the corrugation that is surrounded by the corrugation 16. The angled sections 22 are adjoined on both sides by tubular sections 27. The central, cylindrical interior space 17 of the compensator 15 extends in this example from a free end 28 of a tubular section 27 to the free end 28 of the other tubular section 27 of the compensator 15. The central interior space 17 of the compensator 15 forms a part of the jacket space 10 of the heat exchanger 1. On the free ends 28 of the tubular sections 27, the compensator 15 with the peripheral welds is attached to the respective fluid-exposed inner sides of the connecting parts 19 and 20.

If the tubes 3 undergo lengthwise expansion differently than the jacket parts 13 and 14 during operation of the heat exchanger 1 from FIG. 1 based on temperature differences between the first and second medium, the compensator 15 can equalize it, in which it expands in the lengthwise direction of the tubes 3. The connecting parts 19 and 20 move away from one another in the arrow directions shown in FIG. 2. The gap 23 becomes larger. The expandable compensator 15 prevents the generation of large mechanical stresses in the heat exchanger 1. In order to enable lengthwise expansion of the jacket 2 of the heat exchanger 1 from FIG. 1, a jacket part 14 is supported on a stationary bearing 21, conversely the second jacket part 13 is supported on a bearing 18 that can move in the lengthwise direction.

The heat exchanger 1 shown in FIG. 1 can be used, for example, as a feedstock preheater in a system for producing hydrogen. In this connection, a cold feedstock, such as, for example, natural gas, can be brought into indirect heat exchange with the hot synthesis gas (CO and H2). The cold feedstock flows through the jacket space 10 and the hot synthesis gas flows through the tubes 3 of the heat exchanger 1. In this connection, temperature differences between the feedstock and synthesis gas of up to 300° C. can prevail. The compensator 15 expands and thus prevents high stress on the heat exchanger 1 due to temperature-induced strains.

As FIG. 2 furthermore shows, a thin pipeline 30 projects into the interior space 25 of the corrugation that is surrounded by the corrugation 16 and said pipeline ends at a short distance to the inside of the corrugation 16. This free end 36 of the pipeline 30 is located, as shown in FIG. 1, at the highest possible site within the interior space 25 of the corrugation. The pipeline 30 runs from one end 36 in a first straight section 31 within the interior 25 of the corrugation radially—relative to the heat exchanger 1—to the inside and through the gap 23 into the central interior space 17 of the compensator 15, i.e., into the jacket space 10. This is followed by a first bent section 32. In an adjoining second straight section 32, the pipeline 30 runs in the axial direction parallel to the tubes 3 at a short distance to the inside of the connecting site 19. There follow a second bent section 34 and adjoining it a third straight section 35 that runs radially to the outside and that is inserted into a through opening (hole) 40 in the connecting part 19. The pipeline 30 is fixed on the connecting part 19 by welds 41 and 42 on the inside and outside of the connecting part 19. The weld 41 prevents fluid from the jacket space 10 from travelling into the gap between the pipeline 30 and the through hole 40 and from causing gap corrosion. The pipeline 30 is made of a material piece of high-grade steel (chromium-nickel steel). It has a diameter of roughly 6 mm in this example.

In the region of the through hole 40, a pipe socket 44 is attached to the outside of the connecting part 10 and is connected coaxially to the straight section 35 of the pipeline 30. In the operation of the heat exchanger 1, the pipe socket 44 is sealed with a blind flange 49 as is shown at top right in FIG. 2 in the circled detail view.

When the heat exchanger 1 is not in operation, a pipeline 47 can be connected to the pipe socket 44 by way of a flange 46. The pipeline 47, as also shown in FIG. 1, leads to a pump 50. The pipeline 30, the through hole 40, the pipe socket 44, the pipeline 47 with flange connections, and the pump 50 in this embodiment form a venting device for the compensator 15, which will be explained in more detail below.

During operation of the heat exchanger 1 as a feedstock preheater in a hydrogen plant, natural gas that is routed through the jacket space 10 travels through the gap 23 into the interior 25 of the corrugation. Since part of the peripherally running interior space 25 of the corrugation, as shown in FIG. 1, is located above the jacket parts 13, 14, 19 and 20 of the horizontally installed heat exchanger 1, natural gas, which is lighter than air, remains in this part of the interior space 25 of the corrugation after venting the jacket space 10.

In order to remove the remaining residues of the natural gas from the interior 25 of the corrugation, the pipeline 47 is connected to the pipe socket 44 shown in FIG. 2 and the pump 50 is turned on to produce a low vacuum. In this way, the remaining natural gas, shown by the illustrated arrows, is sucked into the pipeline 22 and is removed from the interior space 25 of the corrugation by way of the pipeline 47 connected to the pipe socket 44. The removed natural gas is blown out by way of the line 48 that is shown in FIG. 1. Thus, complete residual venting of combustible natural gas from the interior space 25 of the corrugation is possible. This enables all maintenance on the heat exchanger to be carried out without danger for the maintenance personnel, also including welding.

In contrast to the embodiment that is shown, it is also possible to connect the pipeline 47 permanently to the pipe socket 44 and to provide it with a valve that is closed in the operation of the heat exchanger 1 and that in the case of necessary venting of the compensator 15 is opened for connection to the pump 50. If the compensator, in contrast to the embodiment that is shown, has several corrugations 16, each corrugation 16 can be provided with a corresponding pipeline 30 and a corresponding number of through holes 40 and pipe sockets 44 can be provided on the jacket of the heat exchanger 1. In this case, the respective pipe sockets 44 can be located distributed over the periphery at the same axial height on the connecting part 19 or 20 or else on the jacket parts 13 and 14 of the heat exchanger 1.

FIG. 3 shows an alternative embodiment of a venting device for a compensator 15′. In this case, FIG. 3 shows the same extract on a heat exchanger 1 as in FIG. 2. Compared to the compensator 15 from FIG. 2, the compensator 15′ shown in FIG. 3 has a narrower passage or gap 23′ between the central interior space 17′ of the compensator 15′ and the interior space 25′ of the corrugation. In this example, the pipeline 30′ with its free end 36′ terminates shortly in front of the gap 23. In comparison to FIG. 2, it does not project into the interior 25′ of the corrugation.

For purposes of ventilation, a vacuum is also produced here using the pump 50 and sucks out the residue of the first medium, here natural gas, from the interior 25′ of the corrugation. In order to reduce the lateral flow of air out of the central interior space 17′ of the compensator 15′ into the pipeline 30′, the line end 36′ should be located as near as possible to the gap 23′. Moreover, it is possible to make the end 36′ as a nozzle with an elongated gap, which is not shown, however.

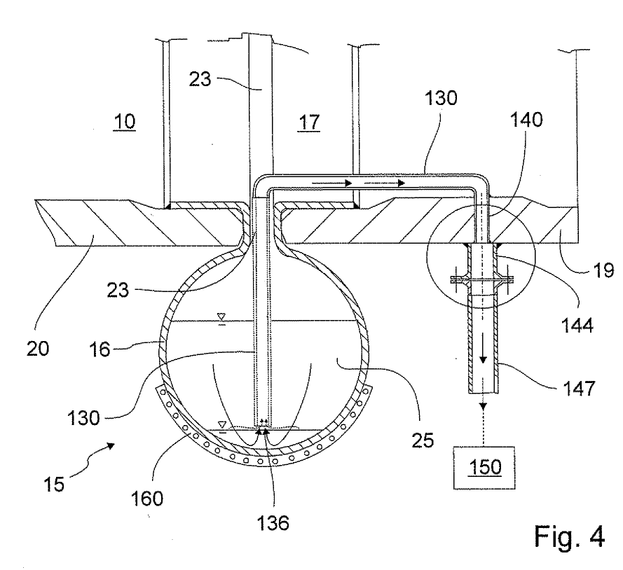

With reference to FIG. 4, it is now assumed that not a gaseous medium, as described with reference to FIGS. 2 and 3, but rather a liquid medium is routed through the jacket space 10 of the heat exchanger 1. One example of this is the use of the heat exchanger 1 as a water preheater in a hydrogen or synthesis gas plant. In this application, hot synthesis gas at a temperature of 450° C. is routed through the tubes 3 of the heat exchanger 1. Cold water is routed in counterflow thereto through the jacket space 10 of the heat exchanger. The water is heated in doing so, and the synthesis gas is cooled by roughly 150° C.

FIG. 4 shows an extract of the heat exchanger 1 shown in FIG. 1 with the compensator 15 in a lower region of the jacket 2. The illustrated extract is shown in FIG. 1 in dotted lines. In this region, the heat exchanger 1 comprises a draining device for residual draining of a liquid medium, here water, from the interior space 25 of the corrugation.

The draining device shown in FIGS. 1 and 4 comprises the same components as the venting device from FIG. 2. The latter are made and arranged, however, in mirror image to those of the venting device from FIG. 2 with reference to a horizontal plane that runs through the lengthwise axis of the heat exchanger 1. In their reference numbers, the parts are increased by 100 compared to those of FIG. 2. The free end 136 of the pipeline 130 is located here at the lowest possible point within the interior space 25 of the corrugation if the pipeline 130, as shown in dotted lines, projects into the interior space 25 of the corrugation. In addition, the draining device comprises an electrical heating means 160 using which the liquid medium located in the interior space of the corrugation 25 can be vaporized. The heating means 160 can be formed by, for example, an electrical heating mat.

In the operation of the heat exchanger 1, water flows from the jacket space 10 through the gap 23 into the interior space 25 of the corrugation. In one region of the interior space 25 of the corrugation, which, as shown in FIG. 1, is underneath the lowest level of the jacket 2, a residue of water remains after draining the jacket space 10 that cannot be removed by gravity. In order to remove this residue, the pump 150 is turned on. The latter produces a negative pressure by which the water is removed through the pipelines 130 and 147 as illustrated by the indicated arrows.

A residue of liquid fluid that remains underneath the lower end 136 of the pipeline 130 in the interior space 25 of the corrugation is vaporized using the heating means 160. The vapor is likewise sucked out by way of the pipeline 130 and the pump 150.

As indicated in FIG. 4, the pipeline 130 can also end shortly above the gap 23 if it cannot be inserted into the interior space 25 of the corrugation. The fluid located in the interior space 25 of the corrugation in this case is vaporized using the heating means 160 and sucked out by way of the shortened line 130.

A venting device as is explained with reference to FIGS. 2 and 3 is not needed when the heat exchanger 1 is being used as a water preheater, but it can be present if the heat exchanger 1 is to be made both for a gaseous medium and also for a liquid medium in the jacket space 10.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding German application No. 102008026596.9, filed Jun. 3, 2008 are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A draining or venting device for a compensator (15; 15′) having means defining a central, especially interior space (17; 17′) and at least one peripheral formation (16; 16′), which surrounds the interior space (25; 25′) the draining or venting device having a suction means (50; 150) for sucking a fluid out of the interior space (25; 25′) of the formation, and a connecting line (30, 47; 30′, 47; 130, 147) for establishing a flow connection between the interior space (25; 25′) of the formation and the suction means (50; 150′), the connecting line (30, 47; 30′, 47; 130, 147) running through the central interior space (17; 17′) of the compensator (15; 15′) and running through a through opening (40; 140), especially a through hole (40; 140), in one wall of a component (19) that is connected to the compensator (15; 15′).

2. A device according to claim 1, wherein the suction means (50; 150) comprises an electrically driven pump (50, 150).

3. A device according to claim 1, wherein the connecting line (30, 47; 30′, 47; 130, 147) projects into the interior space (25; 25′) of the formation of the compensator (15; 15′).

4. A device according to claim 1, wherein the connecting line (30, 47; 30′, 47; 130, 147) leading from the central interior space (17; 17′) of the compensator (15; 15′) ends in front of a passage (23; 23′) that connects the central interior space (17; 17′) of the compensator (15; 15′) to the interior space (25; 25′) of the formation.

5. A device according to claim 1, further comprising a heating means (160) located proximate the formation (16; 16′) for vaporizing a liquid.

6. A device according to one claim 1, wherein
(a) a first, inner part (30; 30′) of the connecting line (30, 47; 30′, 47; 130, 147) comprises a pipeline (30; 30′; 130) that runs through the central interior space (17) of the compensator (15; 15′) and extends as far as or into the through opening (40; 140), and
(b) a second, outer part (47; 147) of the connecting line (30, 47; 30′, 47; 130, 147), which leads to the suction means (50; 150), is flow-connected via a pipe socket (44; 144) that is connected from the outside to the through opening (40; 140) to the first, inner part (30; 30′) of the connecting line (30, 47; 30′, 47; 130, 147).

7. A device according to claim 1 wherein said component (19) is a tabular connecting part and the through opening (40; 140) is located in one wall of said tubular connecting part (19) that is connected to the compensator (15; 15′) and to an inner part (30; 30′; 130) of the connecting line (30, 47; 30′, 47; 130, 147) that runs through the central interior space (17) of the compensator (15; 15′) and extends as far as or into the through opening (40; 140) as a prefabricated unit.

8. A device according to claim 7, wherein in the operation of the compensator (15; 15′), the pipe socket (44; 144) is sealed by a blind flange (49).

9. A device according to claim 1, wherein a first part (30; 30′; 130) of the connecting line (30, 47; 30′, 47; 130, 147) that runs into the central interior space (17) of the compensator (15; 15′) has a diameter of less than 20 mm.

10. A heat exchanger (1), with a compensator (15; 15′) with at least one formation (16, 16′), the compensator (15; 15′) connecting the jacket parts (19, 20) of the heat exchanger to one another, and a draining and/or venting device for the compensator (15; 15′) according to claim 1.

11. In a synthesis gas or hydrogen facility, especially as a preheater, in which a feedstock, especially water or natural gas, is preheated in indirect heat exchange with hot synthesis gas in a heat exchanger, the improvement wherein the heat exchanger is according to claim 10.

12. A device according to claim 1, wherein the means defining a central interest space (17; 17′) defines a cylindrical space.

13. A device according to claim 1, wherein the at least one peripheral formation (16; 16′) comprises corrugations.

14. A device according to claim 12, wherein the at least one peripheral formation (16; 16′) comprises corrugations.

15. A device according to claim 9, wherein said diameter is less than 10 nm.

16. A heat exchanger according to claim 10, being a straight tube heat exchanger.
